(19) United States
(12) Patent Application Publication
(10) Pub. No.: US 2020/0189322 A1
(43) Pub. Date: Jun. 18, 2020

(54) TIRE TREAD

(71) Applicant: The Goodyear Tire & Rubber Company, Akron, OH (US)

(72) Inventors: Roberto Giovanni Sangalli, Hoscheid-Dickt (LU); Matthias Bode, Gruendau (DE); Helmut Wolfgang Fehl, Schluechtern (DE)

(21) Appl. No.: 16/218,914

(22) Filed: Dec. 13, 2018

(51) Int. Cl. B60C 11/03; B60C 11/12

(52) U.S. Cl. CPC B60C 11/0304; B60C 11/1272; B60C 11/1259; B60C 2011/0334; B60C 2011/0381; B60C 2011/0358; B60C 2011/0341; B60C 11/1236

(57) ABSTRACT

A tread for a tire includes a first circumferential main groove, a second circumferential main groove, and a third circumferential main groove. The first, second, and third circumferential main grooves together define a first shoulder rib, a first intermediate rib, a second intermediate rib, and a second shoulder rib. The second shoulder rib has a plurality of first linear, lateral grooves circumferentially alternating with a plurality of second linear, lateral grooves and a plurality of double blind lateral sipes disposed circumferentially midway between each adjacent first lateral groove and second lateral groove. The first and second lateral gooves extend both axially and circumferentially toward the third circumferential main groove. The first lateral grooves terminate nearer the third circumferential main groove than the second lateral grooves.

### FIELD OF THE INVENTION

The present invention relates generally stiffening tread patterns for improving steering performance.

### BACKGROUND OF THE INVENTION

In view of resource saving and global environmental issues, pneumatic tires are increasingly being required to decrease the rolling resistance. The rolling resistance may be decreased by decreasing the energy loss in various rubber components of the tread of a tire. For that purpose, conventionally employed are elastomeric materials having as low heat generation properties as the rubber of the tread. Also, tread and sidewall volume may be decreased. However, if the volume of the tread rubber and/or sidewall rubber is decreased, the noise performance during running, ride comfort, and other performance characteristics tend to deteriorate. If a tread rubber having a low heat generation property is used, the braking performance and steering stability tend to deteriorate. Thus, the reduction of rolling resistance has conventionally had an adverse effect on still other performance characteristics such as steering stability and braking performance.

### DEFINITIONS

The following definitions are controlling for the present invention.

“Axial” and “Axially” means the lines or directions that are parallel to the axis of rotation of the tire.

“Axially Inward” means in an axial direction toward the equatorial plane.

“Axially Outward” means in an axial direction away from the equatorial plane.

“Bead” or “Bead Core” generally means that part of the tire comprising an annular tensile member of radially inner beads that are associated with holding the tire to the rim.

“Belt Structures” or “Reinforcement Belts” or “Belt Package” means at least two annular layers or plies of parallel cords, woven or unwoven, underlying the tread, unanchored to the bead, and having both left and right cord angles in the range from 18 degrees to 40 degrees relative to the equatorial plane of the tire.

“Carcass” means the tire structure apart from the belt structure, tread, undertread over the plies, but including the beads.

“Circumferential” most often means circular lines or directions extending along the perimeter of the surface of the annular tread perpendicular to the axial direction; it can also refer to the direction of the sets of adjacent circular curves whose radii define the axial curvature of the tread, as viewed in cross section.

“Directional Tread Pattern” means a tread pattern designed for specific direction of rotation.

“Equatorial Plane” means the plane perpendicular to the tire's axis of rotation and passing through the center of its tread; or the plane containing the circumferential centerline of the tread.

“Footprint” means the contact patch or area of contact of the tire tread with a flat surface under normal load pressure and speed conditions.

“Groove” means an elongated void area in a tread that may extend circumferentially or laterally in the tread in a straight, curved or zigzag manner. It is understood that all groove widths are measured perpendicular to the centerline of the groove.

“Lateral” means a direction going from one sidewall of the tire towards the other sidewall of the tire.

“Net to gross” means the ratio of the net ground contacting tread surface to the gross area of the tread including the ground contacting tread surface and void spaces comprising grooves, notches and sipes.

“Notch” means a void area of limited length that may be used to modify the variation of net to gross void area at the edges of blocks.

“Ply” means a cord-reinforced layer of rubber coated radially deployed or otherwise parallel cords.

“Radial” and “radially” mean directions radially toward or away from the axis of rotation of the tire.

“Radial Ply Tire” means a belted or circumferentially-restricted pneumatic tire in which at least one ply has cords which extend from bead to bead are laid at cord angles between 65 degrees and 90 degrees with respect to the equatorial plane of the tire.

“Shoulder” means the upper portion of sidewall just below the tread edge.

“Sidewall” means that portion of a tire between the tread and the bead.

“Sipe” means a groove having a width in the range of 0.2 percent to 0.8 percent of the tread width. Sipes are typically formed by steel blades having a 0.4 to 1.6 mm, inserted into a cast or machined mold.

“Tangential” and “Tangentially” refer to segments of circular curves that intersect at a point through which can be drawn a single line that is mutually tangential to both circular segments.

“Tread” means the ground contacting portion of a tire.

“Tread width” (TW) means the greatest axial distance across the tread, when measured (using a footprint of a tire,) laterally from shoulder to shoulder edge, when mounted on the design rim and subjected to a specified load and when inflated to a specified inflation pressure for said load.

“Void Space” means areas of the tread surface comprising grooves, notches and sipes.

### BRIEF DESCRIPTION OF THE DRAWINGS

The present invention will be better understood through reference to the following description and the appended drawings, in which:

FIG. 1 is a schematic radial view of a tread in accordance with the present invention.

FIG. 2 is a schematic partial view of the tread of FIG. 1.

FIG. 3 is a schematic sectional view taken along “3-3” in FIG. 2.

### SUMMARY OF THE INVENTION

A tread for a tire in accordance with the present invention includes a first circumferential main groove, a second circumferential main groove, and a third circumferential main groove. The first, second, and third circumferential main grooves together define a first shoulder rib, a first intermediate rib, a second intermediate rib, and a second shoulder rib. The second shoulder rib has a plurality of first linear, lateral grooves circumferentially alternating with a plurality of second linear, lateral grooves and a plurality of double blind lateral sipes disposed circumferentially midway between each adjacent first lateral groove and second lateral groove. The first and second lateral gooves extend both axially and circumferentially toward the third circumferential main groove. The first lateral grooves terminate nearer the third circumferential main groove than the second lateral grooves.

According to another aspect of the tire tread, the double blind sipes are linear.

According to still another aspect of the tire tread, the double blind sipes are parallel to the first lateral grooves.

According to yet another aspect of the tire tread, the double blind sipes are parallel to the second lateral grooves.

According to still another aspect of the tire tread, the double blind sipes are parallel to both the first lateral grooves and the second lateral grooves.

According to yet another aspect of the tire tread, the double blind sipes have terminal ends farther from the third circumferential main groove than terminations of the first lateral grooves.

According to still another aspect of the tire tread, the double blind sipes have terminal ends farther from the third circumferential main groove than terminations of the second lateral grooves.

According to yet another aspect of the tire tread, the double blind sipes have terminal ends farther from the third circumferential main groove than terminations of both the first lateral grooves and the second lateral grooves.

According to still another aspect of the tire tread, the double blind sipes have widths of between 0.0 mm and 1.5 mm.

According to yet another aspect of the tire tread, the double blind sipes have radial depths between 2.0 mm and 6.0 mm.

A method in accordance with the present invention increases cornering stiffness of a tire tread. The method includes the steps of: circumferentially alternating a plurality of first linear, lateral grooves with a plurality of second linear, lateral grooves in a shoulder of the tire tread; terminating the first lateral grooves nearer to a main groove axially adjacent one side of the shoulder than the second lateral grooves; locating a plurality of double blind lateral sipes circumferentially midway between each adjacent first lateral groove and second lateral groove; and limiting widths of double blind sipes disposed in the shoulder rib of the tire tread to between 0.0 mm and 1.5 mm.

According to another aspect of the method, a further step includes extending the first and second lateral gooves at an angle both axially and circumferentially toward the main groove.

According to still another aspect of the method, the double blind sipes are completely linear.

According to yet another aspect of the method, all of the double blind sipes are parallel to all of the first lateral grooves.

According to still another aspect of the method, all of the double blind sipes are parallel to all of the second lateral grooves.

According to yet another aspect of the method, all of the double blind sipes are parallel to both all of the first lateral grooves and all of the second lateral grooves.

According to still another aspect of the method, the double blind sipes have terminal ends farther from the main groove than terminations of both all of the first lateral grooves and all of the second lateral grooves.

According to yet another aspect of the method, the double blind sipes have uniform widths between 0.0 mm and 1.5 mm.

According to still another aspect of the method, the double blind sipes have uniform radial depths between 2.0 mm and 6.0 mm.

### DETAILED DESCRIPTION OF EXAMPLES OF THE PRESENT INVENTION

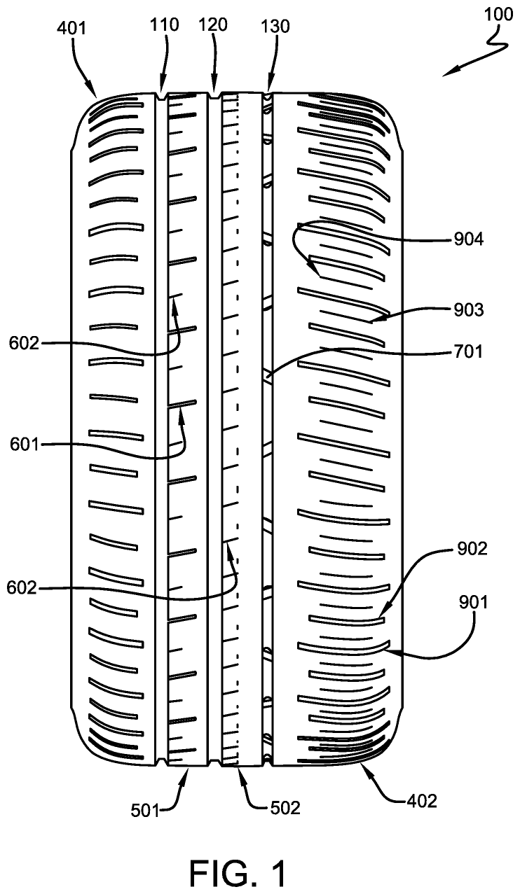

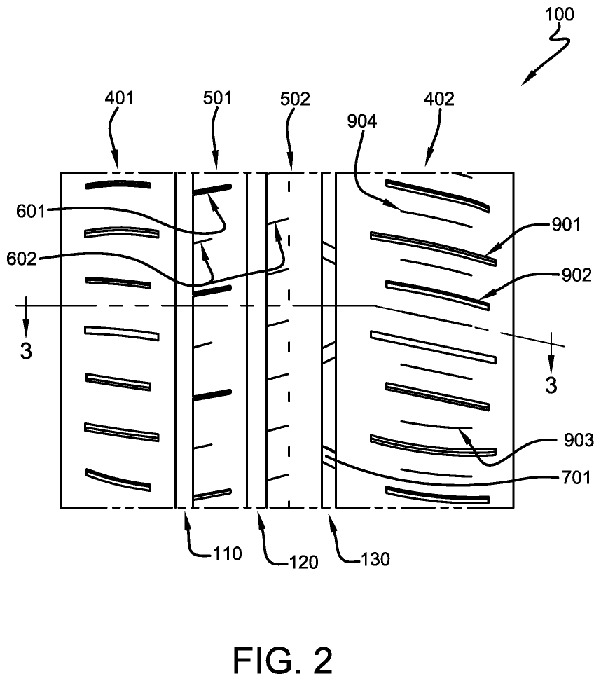

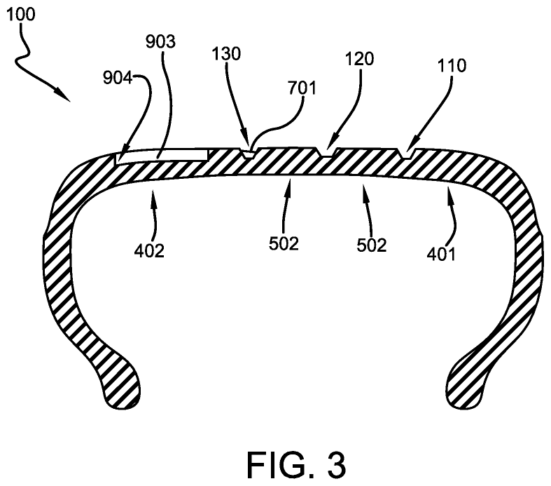

As shown in FIGS. 1 through 3, a tread 100 for use with the present invention may have a first circumferential main groove 110, a second circumferential main groove 120, and a third circumferential main groove 130 defining a first shoulder rib 401, a first intermediate rib 501, a second intermediate rib 502, and a second shoulder rib 402. Each rib 401, 402, 501, 502 may have a variety of transverse grooves 601 and sipes 602 suitable for tire treads. One of the circumferential main grooves 110, 120, 130 (the third groove 130 in FIGS. 1 and 2) may have several connecting bridges 701 spaced circumferentially within the main groove. Similar tread structures are disclosed in U.S. Ser. No. 15/713,730, filed on Sep. 25, 2018 by the current applicant, herein incorporated by reference in its entirety. As many as thirty or more connecting bridges 701 may be included in a single tread 100. As an example, the connecting bridges 701 may connect the axially outer second shoulder rib 402 to the axially inner second intermediate rib.

In accordance with the present invention, the second shoulder rib 402 may have a plurality of first lateral grooves 901 circumferentially alternating with a plurality of second lateral grooves 902. The first and second lateral gooves 901, 902 may be parallel and extend linearly and at an angle, both axially and circumferentially, toward the third circumferential main groove 130. The first lateral grooves 901 may terminate equidistantly nearer the third circumferential main groove 130 than an equidistant termination of the second lateral grooves 902.

Further in accordance with the present invention, the second shoulder rib 402 may include a plurality of double blind, linear, lateral sipes 903 disposed parallel to, and circumferentially midway between, each of the adjacent first and second lateral grooves 901, 902 (FIGS. 1 and 2). The linear sipes 903 may have uniform widths between 0.0 mm and 1.5 mm (e.g., 1.4 mm, 1.3 mm, 1.2 mm, 1.1 mm, 1.0 mm, 0.9 mm, etc.) before attachment to a vehicle and use. The linear sipes 903 may have uniform radial depths between 2.0 mm and 6.0 mm (e.g., 5.5 mm, 5.0 mm, 4.5 mm, 4.0 mm, 3.5 mm, 3.0 mm, etc.). The linear sipes 903 may have terminal ends 904 equidistant and farther from the third circumferential main goove 130 than the first lateral grooves 901 and the second latereral grooves 902.

During cornering of the vehicle, the linear sipes 903 may close down, with the widths decreasing to 0.0 mm. The sides of the linear sipes 903 may thereby interlock or engage each other to reinforce the second shoulder rib 402 during cornering of the attached vehicle. The linear sipes 903 may also provide flexibility to the second shoulder rib 402 during straight ahead motion of the attached vehicle, with the widths remaining as designed between 0.0 mm and 1.5 mm. The linear sipes may further improve cooling and traction of the second shoulder rib 402 of the tread 100 during straight ahead motion of the vehicle.

As shown in FIGS. 1 through 3, such a tread 100 may define an asymmetric tread pattern for performing an advantageous dynamic load transfer in cornering conditions with the outer part of tread getting a higher load and the inside of the tire experiencing reduced load. Therefore, it may be advantageous and much more effective to provide a stiff outside area of a tread 100.

In accordance with the above disclosure, a method in accordance with the present invention may increase cornering stiffness of a tire tread 100, without decreasing flexibility of the tire tread 100 during straight ahead travel. The method may include the steps of: circumferentially alternating a plurality of first linear, lateral grooves 901 with a plurality of second linear, lateral grooves 902 in a shoulder 402 of the tire tread 100; terminating the first lateral grooves 901 nearer to a main groove 130 axially adjacent one side of the shoulder 402 than the second lateral grooves 902; locating a plurality of double blind lateral sipes 903 circumferentially midway between each adjacent first lateral groove 901 and second lateral groove 902; and limiting widths of double blind sipes 903 disposed in the shoulder rib 402 of the tire tread 100 to between 0.0 mm and 1.5 mm.

It is understood that many other variations may be apparent to one of ordinary skill in the art from a reading of the above specification and concurrent drawings. These variations and other variations are within the spirit and scope of the present invention as defined by the following appended claims.

What is claimed:

1. A tread for a tire comprising:
a first circumferential main groove;
a second circumferential main groove; and
a third circumferential main groove, the first, second, and third circumferential main grooves together defining a first shoulder rib, a first intermediate rib, a second intermediate rib, and a second shoulder rib having a plurality of first linear, lateral grooves circumferentially alternating with a plurality of second linear, lateral grooves, and a plurality of double blind lateral sipes disposed circumferentially midway between each adjacent first lateral groove and second lateral groove,
the first and second lateral gooves extending both axially and circumferentially toward the third circumferential main groove, the first lateral grooves terminate nearer the third circumferential main groove than the second lateral grooves.

2. The tread as set forth in claim 1 wherein the double blind sipes are linear.

3. The tread as set forth in claim 1 wherein the double blind sipes are parallel to the first lateral grooves.

4. The tread as set forth in claim 1 wherein the double blind sipes are parallel to the second lateral grooves.

5. The tread as set forth in claim 1 wherein the double blind sipes are parallel to both the first lateral grooves and the second lateral grooves.

6. The tread as set forth in claim 1 wherein the double blind sipes have terminal ends farther from the third circumferential main groove than terminations of the first lateral grooves.

7. The tread as set forth in claim 1 wherein the double blind sipes have terminal ends farther from the third circumferential main groove than terminations of the second lateral grooves.

8. The tread as set forth in claim 1 wherein the double blind sipes have terminal ends farther from the third circumferential main groove than terminations of both the first lateral grooves and the second lateral grooves.

9. The tread as set forth in claim 1 wherein the double blind sipes have widths of between 0.0 mm and 1.5 mm.

10. The tread as set forth in claim 1 wherein the double blind sipes have radial depths between 2.0 mm and 6.0 mm.

11. A method for increasing cornering stiffness of a tire tread, the method comprising the steps of:
circumferentially alternating a plurality of first linear, lateral grooves with a plurality of second linear, lateral grooves in a shoulder of the tire tread;
terminating the first lateral grooves nearer to a main groove axially adjacent one side of the shoulder than the second lateral grooves;
locating a plurality of double blind lateral sipes circumferentially midway between each adjacent first lateral groove and second lateral groove;
limiting widths of double blind sipes disposed in the shoulder rib of the tire tread to between 0.0 mm and 1.5 mm

12. The method as set forth in claim 11 further including the step of extending the first and second lateral gooves at an angle both axially and circumferentially toward the main groove.

13. The method as set forth in claim 11 wherein the double blind sipes are completely linear.

14. The method as set forth in claim 11 wherein all of the double blind sipes are parallel to all of the first lateral grooves.

15. The method as set forth in claim 11 wherein all of the double blind sipes are parallel to all of the second lateral grooves.

16. The method as set forth in claim 11 wherein all of the double blind sipes are parallel to both all of the first lateral grooves and all of the second lateral grooves.

17. The method as set forth in claim 11 wherein the double blind sipes have terminal ends farther from the main groove than terminations of both all of the first lateral grooves and all of the second lateral grooves.

18. The method as set forth in claim 11 wherein the double blind sipes have uniform widths between 0.0 mm and 1.5 mm.

19. The method as set forth in claim 11 wherein the double blind sipes have uniform radial depths between 2.0 mm and 6.0 mm.
